(19) United States
(12) Patent Application Publication
(10) Pub. No.: US 2013/0236843 A1
(43) Pub. Date: Sep. 12, 2013

(54) SOLID OLIVE OIL CANDLE AND METHODS FOR THE PRODUCTION THEREOF

(71) Applicant: NER LAMEA LTD., Modiin Elit (IL)

(72) Inventor: Avi KOSOVSKI-SHAHOR, Modiin Elit (IL)

(73) Assignee: NER LAMEA LTD., Modiin Elit (IL)

(21) Appl. No.: 13/786,965

(22) Filed: Mar. 6, 2013

Related U.S. Application Data
(60) Provisional application No. 61/608,058, filed on Mar. 7, 2012.

(51) Int. Cl. C11C 5/00

(52) U.S. Cl. CPC C11C 5/002
USPC 431/288; 264/40.1

(57) ABSTRACT

A solid olive oil candle possessing a density of at least 750 gr/cm³ and a method for the production thereof.

### FIELD OF THE INVENTION

The present invention is related to compositions for preparing candles, and in particular, for the preparation of solid olive oil candles.

### BACKGROUND OF THE INVENTION

Candles are often used in religious ceremonies of many faiths. In the Jewish religion, for example, candles are used to celebrate or commemorate many occasions and holidays.

A pair of Shabbat candles are lit on Friday evening prior to the start of the weekly Sabbath celebration, whereas on Saturday night, a special braided candle with several wicks is lit for the Havdalah ritual, which marks the end of the Sabbath and the beginning of the new week.

Candles are also lit prior to the onset of the three Jewish festivals (Sukkot, Passover and Shavuot) and the eve of Yom Kippur, and Rosh Hashana.

Also, the eight-day holiday of Chanukkah, also known as the Festival of Lights, is celebrated by lighting a special Chanukkah lamp (“Chanukkiyah”) each night to commemorate the rededication of the Temple in Jerusalem.

A seven day memorial candle is lit following the funeral of a spouse, parent, sibling or child, whereas yearly memorial candles are lit on the anniversary of the death of a loved one.

In the Jewish religion, there is a strong preference for using olive oil when lighting candles, as it is considered a tool for the beautification of a ritual (Hiddur Mitzva). Particularly, when lighting the Shabbat and Chanukkah candles, as olive oil is easily drawn into the wick, its light burns clearly, and to commemorate the fact that the miracle of Chanukkah happened with olive oil.

However, the actual usage of olive oil for lighting candles places a heavy burden on the practitioners of a certain ritual as it involves somehow combining the liquid olive oil with the solid waxed candle prior to lighting.

Due to the chemical properties of olive oil, previous attempts to yield a solid candle comprising olive oil made use of fatty alcohols and/or certain fatty acids as gelatinizing agents to induce gelatinization of the olive oil. However, these and other solutions have enabled the use of only small concentrations of olive oil, and in most cases resulted in semi-solid, jelly-like candles.

### SUMMARY

There is a need for, and it would be useful to have, a solid olive oil based candle. In some demonstrative embodiments, there is provided a homogeneous composition for the preparation of a solid olive oil candle possessing a density of at least 915 gr/cm³. According to some demonstrative embodiments, the composition may contain an amount of olive oil of at least 12% weight per weight of the entire composition (“w/w composition”), preferably, at least 50% w/w composition, and paraffin.

In some demonstrative embodiments, the composition may further contain at least one anti-oxidizing agent, to prevent oxidation of the olive oil.

In some demonstrative embodiments, the composition may further contain at least one ingredient selected from the following group: a mineral oils, vegetable oils, etheric oils, plant extracts and/or aromatic substances.

According to some demonstrative embodiments, there is provided a method for the preparation of a solid olive oil candle as described herein.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows an exemplary, illustrative method according to at least some embodiments of the present invention for preparing a solid olive oil candle; and

FIG. 2 shows an exemplary, illustrative method according to at least some embodiments of the present invention for preparing a solid olive oil candle.

### DETAILED DESCRIPTION OF THE INVENTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components and/or units have not been described in detail so as not to obscure the discussion.

According to some demonstrative embodiments, there is provided an essentially homogeneous composition comprising paraffin and olive oil, for the preparation of solid olive oil candles and methods for the production thereof.

In some demonstrative embodiments, the composition may include relatively large concentrations of olive oil, for example, over 12% w/w composition, preferably over 50% w/w composition, e.g., 75% w/w composition, and optionally up to 90% w/w composition.

According to some embodiments, despite the relatively large concentrations of olive oil in the composition, the present invention provides for an olive oil candle possessing a density of at least 750 gr/cm³, optionally at least 900 gr/cm³, preferably at least 915 gr/cm³, most preferably between 915 to 980 gr/cm³

According to some demonstrative embodiments, the present invention may obviate the need for use of common solutions to try and solidify olive oil candles, as described in detail below. According to some embodiments, the current solutions provide for semi-solid olive oil candles, having low concentrations of olive oil. The present olive oil candles are mostly in a jelly or pseudo-ointment state, and are usually contained in housings to maintain the candle's structure.

In some demonstrative embodiments, the invention described herein provides for a solid olive oil candle, containing relatively large concentrations of olive oil, wherein the candle is sufficiently solid to enable a user of the candle to hold the candle in his hand, and/or to make use of the candle without requiring any housings and/or structure supports of any kind.

The term “homogeneity” and/or “homogeneous” as used herein may refer to a single phase composition, in contrast to heterogeneous compositions, characterized by having two or more phases. According to some embodiments, the composition described herein may be determined to be homogeneous when essentially most of the ingredients have settled and are equal, e.g, characterized by having one substantially unified color.

In some demonstrative embodiments, the olive oil is a fixed oil obtained from ripe olives, the fruit of the cultivated olive tree Olea europaea L., Oleaceae, and in room temperature, olive oil is in the state of a liquid (the melting point is −6° C., wherein the density of olive oil in 15.5° C. is 0.915-0.918 Kg/L and the viscosity is 84 centipoise (cP)).

The composition of olive oil may vary but is generally made up primarily of mixed glycerides of oleic acid (˜55%-83%), of palmitic acid (7.5%-20%), of palmitoleic acid (0.3%-3.5%), of linoleic acid (3.5%-21%), of stearic acid (0.5%-5%) and of arachidic acid (0-0.9%). Minor constituents of olive oil might also include squalene (up to 0.7%) and phytosterol and tocopherols (about 0.2%).

The fatty acids which constitute the olive oil are generally divided into the following groups: SFA—Saturated Fatty Acid, MUFA—Mono Unsaturated Fatty Acid and PUFA—Poly Unsaturated Fatty Acid.

The paraffin, as referred to herein for example, may contain a mixture of alkanes possessing a chain length of between 20 to 40 carbon atoms. Having a density of about 0.9 gr/cm³, and with a melting point of approximately 46° C.-68° C. The paraffin is solid at room temperature, and begins to enter the liquid phase when the temperature is elevated to 39° C. Examples of common paraffins include, paraffin 573, paraffin 103, paraffin 104 and the like. Isopraffins refer to the long chains members of the paraffin group, possessing C₂₀H₄₂ to C₄₀H₈₂ alkanes, also referred to as wax paraffin.

The paraffin, according to some embodiments, may also be a liquid paraffin (also known as mineral oil, Alboline, Glymol, Nujol, Adepsine, medical paraffin or Saxol), and comprise a mixture of heavy alkanes, possessing a density of 0.8 gr/cm³.

In some demonstrative embodiments, the mineral oil may be used to prevent evaporation of liquids during heating. The mineral oil may also be used to prevent reaction between polymers upon heating to high temperatures, for example, 95° C.

According to some embodiments, the composition described herein may include paraffin, wax paraffin, liquid paraffin or any combination thereof.

In some demonstrative embodiments, the composition may include one or more lipophilic (fat-soluble) organic compounds, to enable, for example, the homogeneous dissolution of the olive oil and the paraffin and/or other lipophilic ingredients. Non limiting examples of lipophilic organic compounds include Butylated hydroxytoluene (“BHT”) (also known as butylhydroxytoluene).

In some demonstrative embodiments, the composition may include one or more anti-oxidizing agents and/or anti-ozonants, for example, to prevent the olive oil from undergoing oxidation. Non limiting examples of anti-oxidizing agents include propyl gallate (PG, E310), tertiary butylhydroquinone (TBHQ), butylated hydroxyanisole (BHA, E320) and BHT.

According to some embodiments, the amount and/or concentration of the anti-oxidizing agent, e.g., the BHT, included in the composition correlates to the concentration of the olive oil in the composition, i.e., higher concentrations of olive oil will require the inclusion of higher concentrations of anti-oxidizing agent in the composition. For example, when the composition comprises about 50% or about 90% olive oil, BHT may be used in a concentration of 0.5% or 1%, respectively.

Lipophilic portions of the olive oil may connect to lipophilic portions of the paraffin. In some demonstrative embodiments, the composition may include one or more ingredients or mixtures of ingredients, designed to maintain and/or enhance the connection between the olive oil and paraffin. Possible examples of such ingredients or mixtures of ingredients may include preservative compositions, e.g., a combination of formaldehyde, organic acids and Phenoxyethanol, such as Sharomix 702® and/or Sharomix 706® and the like.

According to some demonstrative embodiments, the composition may also include one or more types of waxes, including, for example, Beeswax, Carnauba wax and the like.

Beeswax is a natural wax produced in the bee hive of honey bees of the genus Apis and it mainly contains esters of fatty acids and various long chain alcohols. An approximate chemical formula for beeswax is C₁₅H₃₁COOC₃₀H₆₁. Its main components are palmitate, palmitoleate, hydroxypalmitate and oleate esters of long-chain (30-32 carbons) aliphatic alcohols, with the ratio of triacontanyl palmitate CH₃(CH₂)₂₉O—CO—(CH₂)₁₄CH₃ to cerotic acid CH₃(CH₂)₂₄COOH, the two principal components, being 6:1. Density at 15° C. is 958 to 970 kg/m³.

Carnauba wax, also referred to as Brazil wax or palm wax (also known as “queen of waxes”), is a wax of the leaves of the palm Copernicia prunifera. Carnauba wax consists mostly of aliphatic esters (40 wt %), diesters of 4-hydroxycinnamic acid (21.0 wt %), ω-hydroxycarboxylic acids (13.0 wt %), and fatty acid alcohols (12 wt %). The compounds are predominantly derived from acids and alcohols in the C26-C30 range. Distinctive for carnauba wax is the high content of diesters as well as methoxycinnamic acid. The melting point of carnauba wax is 82-86° C. whereas the relative density is about 0.97 and it is practically insoluble in water, soluble on heating in ethyl acetate and in xylene, practically insoluble in ethyl alcohol.

The carnauba wax is often too brittle to be used alone, and according to some embodiments, carnauba wax may be combined with other waxes, for example, beeswax, to increase hardness and durability.

In some demonstrative embodiments, the composition may include additional ingredients, for example, to provide better homogeneity and/or to provide a certain color, odor and the like.

According to some embodiments, ingredients which may facilitate the homogeneity of the composition, may include, but are not limited to, vegetable oils and/or mineral oils. Suitable examples of vegetable oils may include soy oil, canola oil, sunflower oil, coconut oil, almond oil, grape seed oil and the like. Suitable examples of mineral oils may include glycerin, Vaseline (white petrolatum) and the like.

In some demonstrative embodiments, the composition may include aromatic ingredients which create and/or enhance a certain fragrance, odor or scent. For example, the composition may include one or more aromatic oils, including lavender, Ylang ylang, Vanilla, French-Vanilla, Sandalwood, Cedar, Mandarin, Cinnamon, Lemongrass, Rosehip, Peppermint, Coconut, Sahara, honey, Patchouli (POGOSTEMON CABLIN), Geranium, carob (ceratonia siliqua) and the like.

In some demonstrative embodiments, the composition may include etheric oils and/or etheric ingredients, e.g., to improve the scent of the candles. For example, the composition may include one or more etheric oils, including Oblipicha, Jujuba, Geranium and the like.

In some demonstrative embodiments, the composition may include one or more plant extracts, which may be used for example, to enhance certain religious aspects and virtues of the composition. For example, the one or more plant extracts may include Lecithin, Opuntia Ficus-Indica, Opuntia Vulgaris, Anastatica Hierochuntica.

According to some embodiments, the candle of the present invention may be used with a standard wick as is known in the art. However, in order to enable stable and clear burning of the solid olive oil candle described herein, according to some embodiments, there is provided a multi-fiber wick, which overcomes the drawbacks of the wicks currently in use, e.g., unstable and/or cloudy flame and the like. In some demonstrative embodiments, the multi-fiber wick has been especially designed to enable the proper burning of the flame of a solid olive oil candle.

Typically, a candle wick is a string, cord, or wooden object that holds the flame of a candle, e.g., working via capillary action, i.e., drawing (“wicking”) the fuel to the flame.

In some demonstrative embodiments, the composition described herein comprises two or more substances which have different viscosity and/or rheology characteristics, thus affecting the adhesion and/or cohesion onto the wick of the solid olive oil candle.

Accordingly, the time of burn and/or flame characteristics is dependent on the chosen wick. According to some demonstrative embodiments, a standard single wick may not be suitable for use in a solid olive oil candle as described herein.

According to some embodiments, the multi-fiber wick may include, for example, one or more fibers and/or yarns selected from the following group: fishing wire (nylon), cotton, linen, utah fabric, canvas and fiberglass and the like. According to some embodiments, the multi-fiber wick may include fibers of different diameter and/or denier (also referred to as “den”).

For example, according to some demonstrative embodiments, the multi-fiber wick may include a Fishing wire (nylon) having from 0.13 to 0.90 den, Cotton yarn from 0.7 to 30 den, from 3 to 20 woven fibers, and fiberglass yarn having a thickness of 0.3 to 0.8 mm

In some demonstrative embodiments, the multi-fiber wick may be determined according to the solid olive oil candle produced. For example, candles which are meant to burn for longer periods of time, e.g., for candles produced or designed for burning from 24 hours and up to 7 days or longer, are to include a multi-fiber wick suitable for long time burning, e.g., a multi-fiber wick including a woven cotton fiber together with a fishing wire (nylon) fiber having a thickness of 0.2 to 0.6 mm According to some embodiments, the woven cotton fiber may include 16 to 18 fibers having between 0.7 and 20 den. In some demonstrative embodiments, the type of wick (a multi-fiber or a single fiber) may be chosen according to the composition of the solid olive oil candle produced. For example, candles which include aromatic ingredients are to include a wick suitable for sustaining aromatic oils, e.g., a single or a double stranded wick including a woven cotton fiber together with 2-3 fiberglass fibers having a thickness of 0.3 to 0.8 mm According to these embodiments, the woven cotton fiber may include 18 to 20 fibers.

In some demonstrative embodiments, there is provided a method for the preparation of a composition as described hereinabove, including separately warming paraffin in a container, for example, up to its melting point, e.g., between 45° C.-68° C., preferably, between 45° C.-50° C., and separately warming olive oil up to a point wherein homogeneous liquid olive oil is obtained.

According to preferred embodiments, the temperature of the olive oil is not elevated above a certain degree, e.g., 80° C., in order to avoid breakage of the isomeric structure of the olive oil. According to some embodiments, the temperature of the olive oil may be raised up to a range between 50° C.-70° C., preferably, between 60° C.-65° C., and more preferably, no more than 65° C.

Preferably, one or more anti-oxidizing agents are added to the olive oil, e.g., to prevent oxidation of the olive oil, and provide longer shelf life for the resulting solid olive oil candle.

In some demonstrative embodiments, after separately heating the paraffin and the olive oil, they are mixed together. Preferably, the melted paraffin is added into the heated olive oil, to produce a homogeneous mixture. Preferably, the olive oil should not be added to the paraffin as this may cause undesired solidification of the paraffin.

According to some demonstrative embodiments, the present invention obviates the need for the use of housings for containing semi-solid candles, as the resulting mixture may be solidified to provide a solid olive oil candle, which possesses a density of at least 915 gr/cm³.

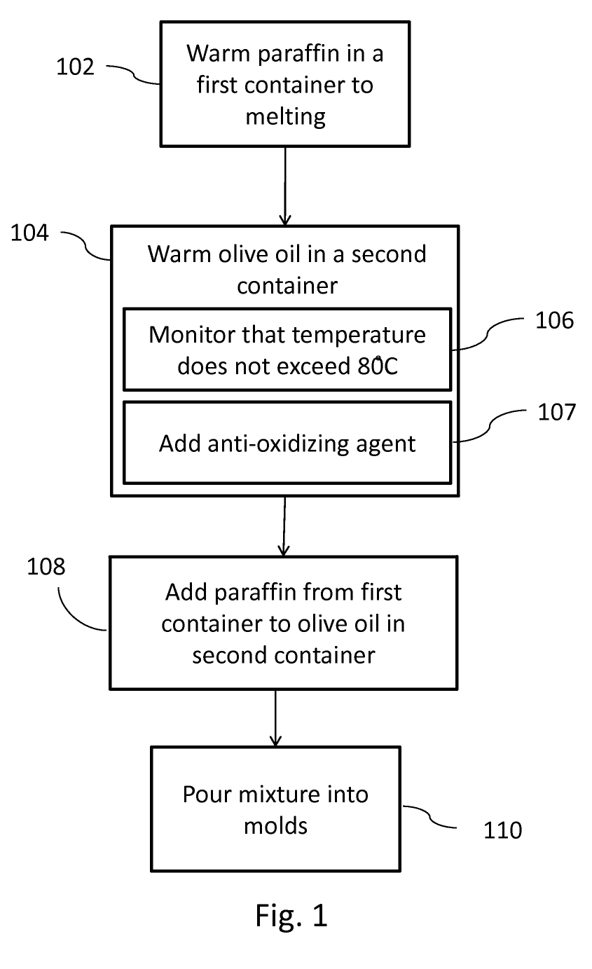

Reference is now made to FIG. 1, which schematically illustrates an exemplary, illustrative method according to at least some embodiments of the present invention for preparing a solid olive oil candle.

According to some demonstrative embodiments, as shown in block 102, the method may include warming paraffin in a first container by elevating the temperature until the paraffin is melted down. In some demonstrative embodiments, the temperature may be raised up to a range between 40° C.-68° C., preferably, between 45° C.-50° C.

According to some demonstrative embodiments, as shown in block 104, the method may include warming olive oil in a second container by elevating the temperature to allow the olive oil to reach a homogeneous liquid state.

In some demonstrative embodiments, the temperature may be raised up to a range between 50° C.-80° C., preferably, between 60° C.-65° C. According to some demonstrative embodiments, as shown in block 106, the temperature should be monitored, and not elevated over 80° C., and preferably, not over 65° C., for example, to avoid breakage of isomeric structures of the olive oil molecules.

According to some demonstrative embodiments, as shown in block 107, warming the olive oil in the second container may include adding one or more anti-oxidizing agent, e.g., BHT.

According to some demonstrative embodiments, as shown in block 108, the method may include adding the melted paraffin from the first container to the warm olive oil in the second container. According to some embodiments, the temperature of the second container is maintained in a range between 50° C.-80° C., to enable homogenous unification of the paraffin and the olive oil.

According to some demonstrative embodiments, as shown in block 110, the resulting mixture may be transferred into suitable molds, e.g., having an elongated shape, to enable the solidification of the mixture in a desired candle shape. In some embodiments, the molds are kept at a temperature which is lower than 50° C., e.g., room temperature, to enable the proper solidification of the mixture.

According to some embodiments, a wick, e.g., a multi-fiber wick, may be incorporated into the mixture upon transfer to the molds.

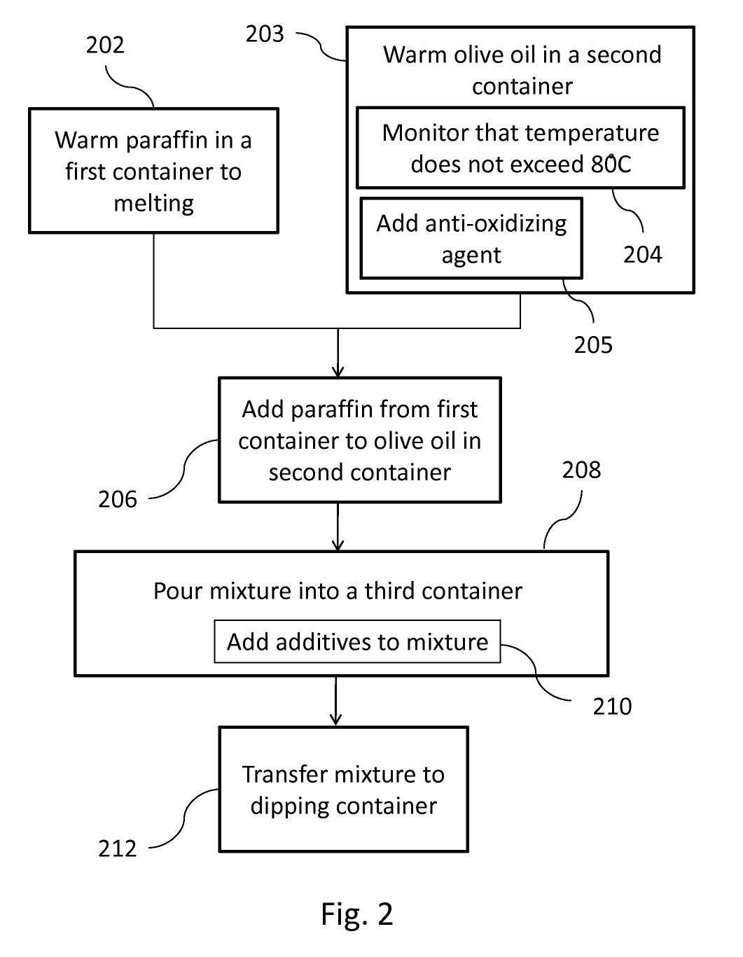

Reference is now made to FIG. 2, which schematically illustrates an exemplary, illustrative method according to at least some embodiments of the present invention for preparing a solid olive oil candle.

According to some demonstrative embodiments, as shown in block 202, the method may include warming paraffin in a first container by elevating the temperature until the paraffin is melted. In some demonstrative embodiments, the temperature may be raised up to a range between 40° C.-68° C., preferably, between 45° C.-50° C.

According to some demonstrative embodiments, as shown in block 203, the method may include warming olive oil in a second container by elevating the temperature to allow the olive oil to reach a homogeneous liquid state.

In some demonstrative embodiments, the temperature may be raised up to a range between 50° C.-80° C., preferably, between 60° C.-65° C. According to some demonstrative embodiments, as shown in block 204, the temperature should be monitored, and not elevated over 80° C., and preferably, not over 65° C., for example, to avoid breakage of isomeric structures of the olive oil molecules.

According to some demonstrative embodiments, as shown in block 205, warming the olive oil may include adding one or more anti-oxidizing agent, e.g., BHT.

According to some demonstrative embodiments, as shown in block 206, the method may include adding the melted paraffin from the first container to the warm olive oil in the second container to obtain a mixture.

According to some demonstrative embodiments, as shown in block 208, the method may include pouring the mixture into a third container at a temperature in a range between 50° C.-65° C., preferably between 55° C.-60° C. (also referred to herein as the “mixing temperature”). According to some embodiments, the mixing temperature is an elevated temperature which enables to bring and/or keep the homogeneous mixture in a liquid state. For example, a preferred elevated temperature may be 70° C.

In some demonstrative embodiments, the method may include mixing the homogeneous liquid olive oil and the melted paraffin until a homogenous mixture is received (also referred to herein as the “base composition”).

According to some demonstrative embodiments, as shown in block 210, other ingredients and/or additives may be added to the base composition, including, for example, essential oils, aromatic oils, plant extracts, fragrance and/or color additives and the like, to yield a final composition.

According to some demonstrative embodiments, as shown in block 212, the final composition may be transferred to a dipping container, to enable the solidification of the composition in a desired shape.

In some demonstrative embodiments, the dipping container may be kept at a temperature to enable the proper solidification of the final composition (“solidification temperature”), e.g., at a temperature which is lower than the mixing temperature. For example, the solidification temperature may be at a range between 50° C.-65° C., preferably, between 50° C.-55° C., most preferably at a temperature of 52° C.

According to some embodiments, additional solidifying ingredients may be added to the dipping container, to enable better solidification of the final composition, including, for example, Beeswax. In some demonstrative embodiments, the Beeswax may provide a rigid coating to the olive oil candle at room temperature.

According to some embodiments, a wick, e.g., a multi-fiber wick, may be incorporated into the final composition upon transfer into the dipping container.

### EXAMPLES

### Olive Oil Paraffin Compositions For the Preparation of Solid Olive Oil Candles

Reference is now made to the following examples, which together with the above description, illustrate the invention in a non-limiting fashion.

### Example 1

### Composition For A Solid Olive Oil Candle

TABLE 1

| | % (wt/wt of the |
|---|---|
| Ingredient | composition/candle) |
| Olive Oil | 70-90 |
| Paraffin | 10-15 |
| Glycerin | 5-10 |
| Lecithin | 1 |
| BHT | 0.2 |
| Coloring agent | 0.4 |
| Fragrance agent | 0.8 |

### Example 2

### Composition For A Solid Olive Oil Candle

TABLE 2

| | % (wt/wt of the |
|---|---|
| Ingredient | composition/candle) |
| Olive Oil | 50-70 |
| Paraffin | 10-20 |
| Beeswax | 15-25 |
| Coconut oil | 6 |
| Coloring agent | 0.2 |
| Processed honey | 1.8 |

### Example 3

### Solid Olive Oil Candle Production Process Model 1

Paraffin “573” is heated in a first container to a temperature between 46° C. and 58° C. Olive oil having a pH between 1.2 and 5.3 is then heated in a second container to a temperature between 65° C. and 70° C.,

BHT in an amount which equals 0.2% w/w composition, is then added to the second container at a temperature between 65° C. and 70° C. Warm paraffin in an amount equal to 6-50% of the total composition weight, is transferred from the first container to the second container at a temperature between 65° C. and 7° C.

The resultinig mass is then transferred to a third container, and mixed at a temperature between 72° C. and 78° C. The mixture is transferred to molds at room temperature.

### Example 4

### Solid Olive Oil Candle Production Process Model 2

Paraffin “103” is heated in a first container to a temperature between 75° C. and 80° C. Olive oil having a pH between 1.2 and 5.3 is (hen heated in a second container to a temperature between 70° C. and 80° C.

BHT in an amount which equals 0.8% w/w composition, is then added to the second container at a temperature between 70° C. and 80° C. Warm paraffin in an amount equal to 6-20% of the total composition weight, is transferred from the first container to the second container at a temperature between 75° C. and 80° C.

The resulting mass is then transferred to a third container, and mixed at a temperature between 75° C. and 80° C. The mixture is transferred to molds at room temperature.

### Example 5

### Solid Olive Oil Candle Production Process: Aromatic Candles

Melting “classic palm oil” in a first container to a temperature between 45° C. and 85° C.′ and adding aromatic extracts to provide a mixture. Olive oil having a pH between 1.2 and 5.3 is then heated in a second container to a temperature between 65° C. and 70° C.

The mixture is transferred from the first container to the second container in an amount equal to 6-20% of the total composition weight. The resulting mass is then transferred to a third. container, and mixed at a temperature between 70° C. and 75° C. The mixture is transferred to molds at room temperature.

### Example 6

### Solid Olive Oil Candle Production Process: Candles For 24 Hour Up To 7 Day Burning

Paraffin “573” is heated in a first container to a temperature between 46° C. and 58° C. Olive oil having a pH between 1.2. and 5.3 is then heated in a second container to a temperature between 65° C. and 70° C.

BHT in an amount which equals 1.5% of the total composition weight, is then added to the second container at a temperature between 65° C. and 70° C. Warm paraffin in an amount equal to 6 50% of the total composition weight, is transferred from the first container to the second container at a temperature between 65° C. and 70° C.

The resulting mass is then transferred to a third container, and mixed at a temperature between 75° C. and 80° C. The mixture is transferred to tin containers or glasses possessing a volume between 120-750 ml, at a temperature between 75° C. and 80° C.

### Example 7

### Solid Olive Oil Candle Production Process: Decorated Candles (“Havdalah Candles”)

Paraffin “573” is heated in a first container to a temperature between 46° C. and 58° C. Olive oil having a pH between 1.2. and 5.3 is then heated in a second container to a temperature between 70° C. and 80° C.

Warm paraffin in an amount equal to 6-50O% of the total composition weight, is transferred from the first container to the second container at a temperature between 65° C. and 70° C.

Brazilian Carnauba Wax is heated in a third container at a temperature between 65° C. and 75° C. and then an amount equal to 5-20% of the total composition weight is transferred to the second container at a temperature between 65° C. and 70° C.

The resulting mass is then transferred to a fourth container, and mixed at a temperature between 75° C. and 80° C. The mixture is transferred to obelisk molds possessing a volume between 300-400 ml, at a temperature between 75° C. and 80° C. to form candles.

Natural beeswax is heated in a dipping tank. at a temperature between 50° C. and 60° C., and the formed candles are dipped into the dipping tank to yield decorated beeswax coated. candies.

It will be appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination. It will also be appreciated by persons skilled in the art that the present invention is not limited by what has been particularly shown and described hereinabove. Rather the scope of the invention is defined only by the claims which follow.

What is claimed is:

1. A candle having a density of at least 750 gr/cm³ comprising at least 12% w/w composition olive oil and at least 5% w/w composition paraffin.

2. The candle of claim 1, comprising at least 50% w/w composition olive oil.

3. The candle of claim 2, comprising at least 75% w/w composition olive oil.

4. The candle of claim 1, further comprising at least one anti-oxidizing agent.

5. The candle of claim 4, wherein said anti-oxidizing agent is Butylated hydroxytoluene (“BHT”).

6. The candle of claim 1, further comprising a multi-fiber wick.

7. The candle of claim 1, further comprising at least one of a mineral oil, vegetable oil and etheric oil.

8. The candle of claim 1, further comprising at least one plant extract selected from a group including: Lecithin, Opuntia Ficus-Indica, Opuntia Vulgaris and Anastatica Hierochuntica.

9. The candle of claim 1, further comprising at least one aromatic substance selected from the group including: lavender, Ylang ylang, Vanilla, French-Vanilla, Sandalwood, Cedar, Mandarin, Cinnamon, Lemongrass, Rosehip, Peppermint, Coconut, Sahara, honey, Patchouli (POGOSTEMON CABLIN), Geranium and carob (ceratonia siliqua).

10. A candle having a density of at least 915 gr/cm³ comprising at least 50% w/w composition olive oil and a multi-fiber wick.

11. The candle of claim 10, comprising at least 75% w/w composition olive oil.

12. The candle of claim 10, further comprising Butylated hydroxytoluene (“BHT”).

13. The candle of claim 10, wherein said multi-fiber wick is selected from a group including fishing wire (nylon), cotton, linen, utah fabric, canvas and fiberglass.

14. The candle of claim 10, wherein said candle is designed to burn from 24 hours to 7 days.

15. The candle of claim 10, further comprising at least one of a mineral oil, vegetable oil and etheric oil.

16. A method of producing a candle, comprising:
warming paraffin in a first container to a melting point to provide a liquid paraffin;
warming olive oil in a second container by elevating the temperature to allow the olive oil to reach a homogeneous liquid state;
adding the liquid paraffin of the first container to the olive oil in the second container; and
pouring the resulting mixture into molds;
wherein said candle has a density of at least 915 gr/cm³.

17. The method of claim 16, wherein said temperature of the second container is monitored not to exceed 80° C.

18. The method of claim 17, wherein said temperature of the second container is monitored not to exceed 65° C.

19. The method of claim 16, wherein said olive oil is in a concentration of at least 50% w/w composition.

20. The method of claim 19, wherein said olive oil is in a concentration of at least 75% w/w composition.
